(19) United States
(12) Patent Application Publication
(10) Pub. No.: US 2015/0047573 A1
(43) Pub. Date: Feb. 19, 2015

(54) REMOVABLE SKIN FOR ANIMAL ENCLOSURE

(71) Applicant: Sandra Tam, Redondo Beach, CA (US)

(72) Inventor: Sandra Tam, Redondo Beach, CA (US)

(21) Appl. No.: 13/966,973

(22) Filed: Aug. 14, 2013

(51) Int. Cl. A01K 1/015; A01K 1/02; A01K 1/035

(52) U.S. Cl. CPC A01K 1/015; A01K 1/0356; A01K 1/0236
USPC 119/497; 119/161; 119/51.01; 119/28.5

(57) ABSTRACT

A skin apparatus for removable use with an animal enclosure, the apparatus comprising a bottom wall and a side wall integral with the bottom wall substantially along a side wall bottom edge and extending therefrom so as to terminate in an opposite side wall top edge, the distance between the side wall bottom edge and the side wall top edge defining an effective height of the apparatus so as to be removably engaged with the enclosure.

### RELATED APPLICATIONS

Not applicable.

### INCORPORATION BY REFERENCE

Applicant(s) hereby incorporate herein by reference any and all patents and published patent applications cited or referred to in this application.

### BACKGROUND OF THE INVENTION

1. Field of the Invention

Aspects of this invention relate generally to animal enclosures, and more particularly to removable skins for animal enclosures to facilitate their cleaning and maintenance.

2. Description of Related Art

The following art defines the present state of this field:

Generally, in connection with cleaning and maintaining the cage, tank, or other such enclosure of an animal there involves taking the cage apart, at least partially, manually removing the soiled shavings/bedding or other material from the bottom portion of the cage, washing and drying the cage as appropriate, and reassembling the cage. This is therefore a relatively time-consuming, inconvenient, and messy or even at times biologically hazardous task.

In attempting to address the foregoing problem of regularly cleaning and maintaining an animal enclosure, known approaches include various kinds of liners or pads made of thin plastic such as polyethylene, waxed paper, or some kind of foam or other absorbent material that are placed at the bottom of the enclosure, such as beneath the shavings/bedding, gravel, or other material peculiar to the habitat of the animal being housed, with the idea being that when such material and/or the liner or pad itself becomes soiled and is to be replaced as part of cleaning out the enclosure, the enclosure is opened and the liner and pad and any material thereon is removed from the enclosure and disposed of, with a fresh liner or pad and any other material therefor as appropriate simply replaced at the bottom of the enclosure without having to wash and dry the bottom of the enclosure itself. This same approach is used in connection with litter box liners in the form of sheets with drawstrings incorporated in their perimeters to secure the liners about the upper lip of the box.

Inherent in such prior art liners and pads for animal enclosures are the drawbacks that either they do not extend vertically so as better capture soiled materials, which is the case with bird cage liners and the like that are formed as planar sheets of plastic or wax paper, or if they do extend vertically, as with a litter box liner, they are not contoured or configured to better conform to the enclosure geometry and/or are made of a relatively thin and easily compromised material that an animal can chew through, damaging and to an extent rendering ineffective the liner or even potentially harming the animal as when bits of the liner are ingested and thereby cause choking or other issues with the animal's digestive system. Furthermore, such liners and pads do not provide or easily incorporate other features or functionality such as receptacles for food and water, perches, and the like.

What is needed and has heretofore been unavailable is a removable skin for an animal enclosure that is configured to better approximate or conform to the enclosure's inside or outside surfaces and is constructed in such a manner as to be resistant to damage by the animal and to even accommodate additional functional features. Aspects of the present invention fulfill these needs and provide further related advantages as described in the following summary.

### SUMMARY OF THE INVENTION

Aspects of the present invention teach certain benefits in construction and use which give rise to the exemplary advantages described below.

The present invention solves the problems described above by providing a skin apparatus for removable use with an animal enclosure. The apparatus provides, in the exemplary embodiment, a bottom wall and a side wall integral with the bottom wall substantially along a side wall bottom edge and extending therefrom so as to terminate in an opposite side wall top edge, the distance between the side wall bottom edge and the side wall top edge defining an effective height of the apparatus so as to be removably received within the enclosure through a door thereof or about the outside of the enclosure, as the case may be.

A primary objective inherent in the above described apparatus and method of use is to provide advantages not taught by the prior art.

Another objective is to provide such an apparatus that substantially conforms to the dimensions of the enclosure.

Yet another objective is to provide such an apparatus that is formed of a semi-rigid plastic or cardboard material.

Other features and advantages of aspects of the present invention will become apparent from the following more detailed description, taken in conjunction with the accompanying drawings, which illustrate, by way of example, the principles of aspects of the invention.

### BRIEF DESCRIPTION OF THE DRAWINGS

The accompanying drawings illustrate aspects of the present invention. In such drawings:

FIG. 1 is an exploded perspective view of an exemplary removable skin apparatus, in accordance with at least one embodiment, positioned adjacent a top-opening conventional wire cage having a rectangular shape;

FIG. 2 is an enlarged perspective view thereof with the apparatus now positioned within the closed cage and housing a rodent along with shavings, food and water, in accordance with at least one embodiment;

FIG. 3 is a reduced scale perspective view thereof illustrating the removal of the apparatus from the open cage with the rodent in an adjacent temporary enclosure, as when the shavings have become soiled and the apparatus is to be replaced, in accordance with at least one embodiment;

FIG. 4 is an exploded perspective view of an alternative exemplary removable skin apparatus, in accordance with at least one embodiment, positioned adjacent a top-opening conventional wire cage having a circular shape;

FIG. 5 is an enlarged perspective view thereof with the apparatus now positioned within the closed cage and housing a bird along with a perch, in accordance with at least one embodiment;

FIG. 6 is a reduced scale perspective view thereof illustrating the removal of the apparatus from the open cage with the bird on the perch temporarily positioned adjacent the cage, as when there are droppings in the apparatus and it is to be replaced, in accordance with at least one embodiment;

FIG. 7 is a perspective view of a further alternative exemplary removable skin apparatus, in accordance with at least one embodiment, positioned within a closed conventional wire cage having a rectangular shape;

FIG. 8 is a perspective view of a still further alternative exemplary removable skin apparatus positioned within a closed conventional glass tank housing a lizard along with gravel, in accordance with at least one embodiment;

FIG. 9 is an exploded perspective view of a still further alternative exemplary removable skin apparatus, in accordance with at least one embodiment, positioned adjacent a conventional wire cage having a rectangular shape and a support base with drawer;

FIG. 10 is an exploded perspective view of a still further alternative exemplary removable skin apparatus, in accordance with at least one embodiment, positioned adjacent a partial-side-opening conventional wire cage having a rectangular shape;

FIG. 11 is an exploded perspective view of a still further alternative exemplary removable skin apparatus, in accordance with at least one embodiment, positioned adjacent an end-opening conventional wire cage having a rectangular shape;

FIG. 12 is an exploded perspective view of a still further alternative exemplary removable skin apparatus, in accordance with at least one embodiment, positioned adjacent a conventional wire cage having a rectangular shape;

FIG. 13 is a perspective view thereof with the cage now positioned within the apparatus, in accordance with at least one embodiment;

FIG. 14 is a perspective view of a still further alternative exemplary removable skin apparatus, in accordance with at least one embodiment, positioned in a first operational mode about the base of a conventional wire cage having a rectangular shape; and

FIG. 15 is a reduced scale perspective view thereof illustrating the apparatus in a second operational mode, as when the cage is to be transported employing the apparatus, in accordance with at least one embodiment.

The above described drawing figures illustrate aspects of the invention in at least one of its exemplary embodiments, which are further defined in detail in the following description. Features, elements, and aspects of the invention that are referenced by the same numerals in different figures represent the same, equivalent, or similar features, elements, or aspects, in accordance with one or more embodiments.

### DETAILED DESCRIPTION OF THE INVENTION

The above described drawing figures illustrate aspects of the invention in at least one of its exemplary embodiments, which are further defined in detail in the following description.

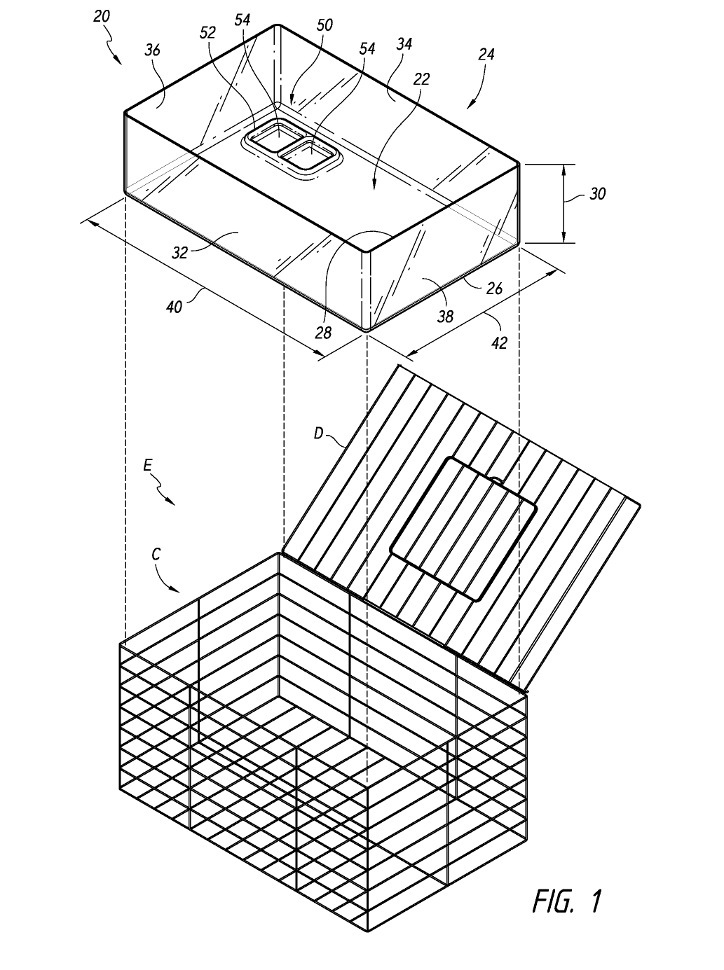

Turning now to FIG. 1, there is shown an exploded perspective view of an exemplary embodiment of a skin apparatus 20 according to aspects of the present invention adjacent to a representative enclosure E as might house a small animal. As shown in the illustrated embodiment, the enclosure E is more particularly configured as a cage C of wire construction and a substantially rectangular shape as is known in the art and with a door D comprising effectively the top wall of the cage C hinged on or along one edge. Those skilled in the art will appreciate, generally and with reference to the further alternative embodiments shown and described herein, that the enclosure E can take a virtually infinite number of forms, now known or later developed, without departing from the spirit and scope of the invention. Fundamentally, it is to be understood that any such enclosure E is strictly for context and forms no part of the disclosed and claimed invention, which skin apparatus
can take a number of forms and configurations accordingly in removably fitting within any such enclosure E, as again will be appreciated with reference to the various alternative exemplary embodiments disclosed herein.

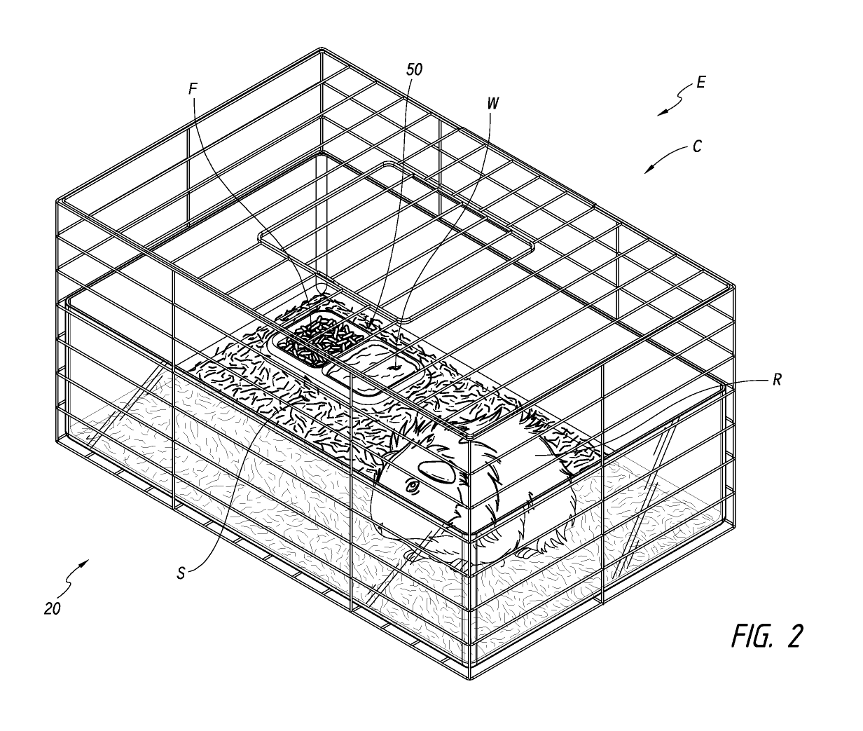

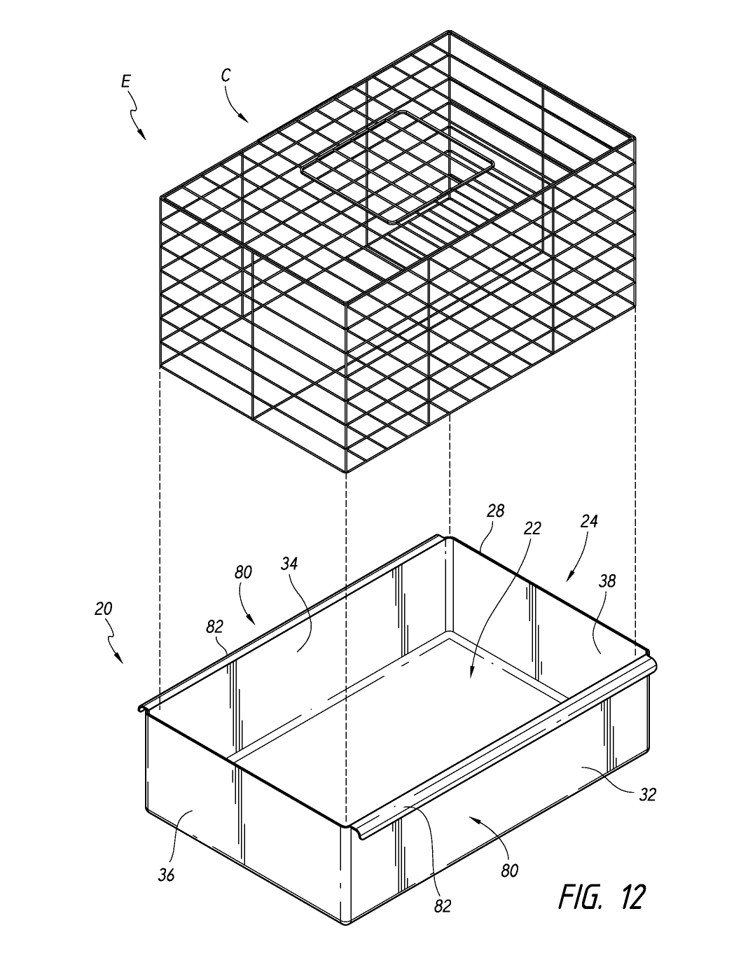

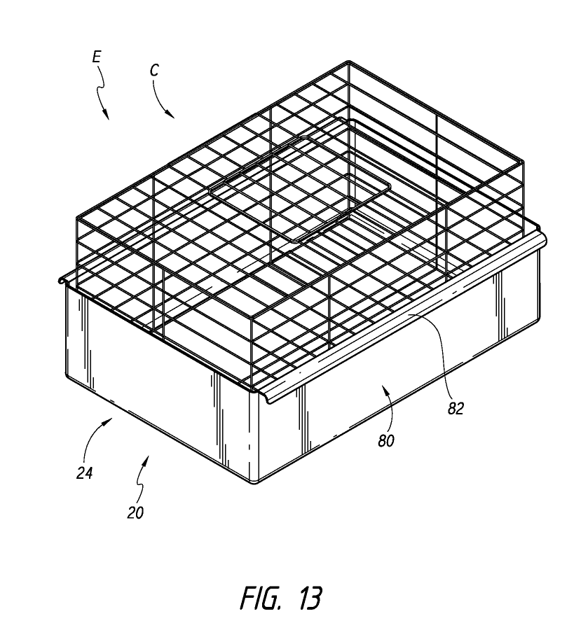

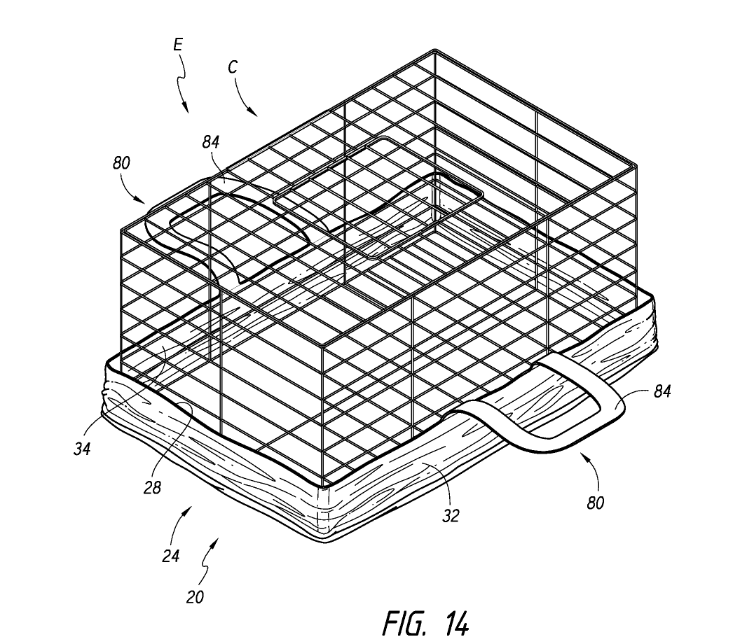

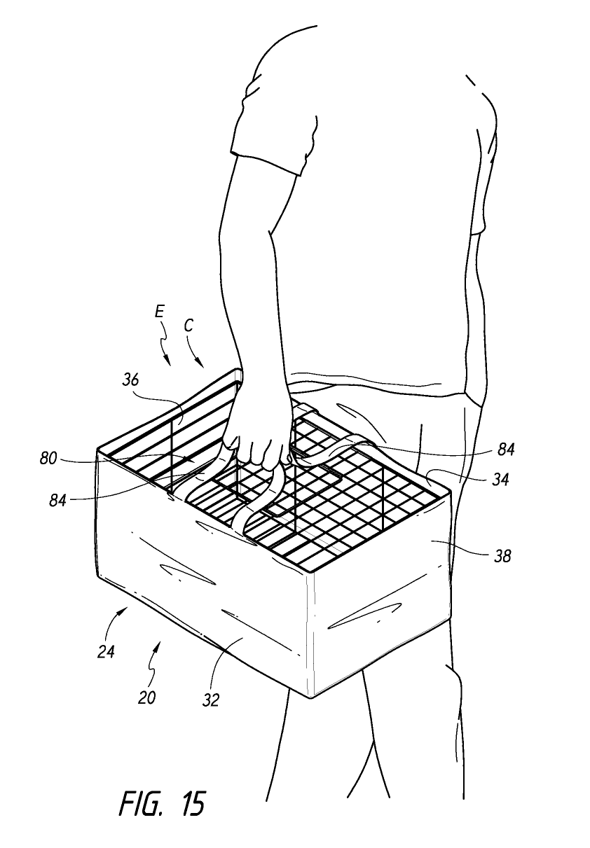

With continued reference to FIG. 1, the skin apparatus 20 comprises, in one embodiment, a bottom wall 22 and four integral side walls 24. More particularly, the apparatus 20 being configured for removable receipt within the illustrated rectangular wire cage C in the first exemplary embodiment, the apparatus 20 is formed having a substantially rectangular shape as well, including relatively longer and of substantially the same length and height opposite front and rear walls 32, 34 and relatively shorter and of substantially the same length and height opposite left and right walls 36, 38, all such walls being interconnected so as to form a substantially unitary apparatus 20. It will be appreciated by those skilled in the art that the walls can be formed separately and then assembled together or the entire apparatus 20 can be formed integrally as through a molding or any other such fabrication technique employing any appropriate material now known or later developed, more about which is said below. Accordingly, the long sides or edges of the bottom wall 22 along which are joined the front and rear walls 32, 34 define a length 40 of the apparatus 20, and the short sides or edges of the bottom wall 22 along which are joined the left and right walls 36, 38 define a width 42 of the apparatus 20. As shown and described, each such side wall 24 is thus formed having a side wall bottom edge 26 along which the respective side walls 24 are joined to the bottom wall 22 and an opposite side wall top edge 28, the distance between respective side wall bottom and top edges 26, 28 defining the height 30 of the apparatus 20. While a unitary height thereabout is shown, those skilled in the art will appreciate that not all walls 24 need be the same geometry and thus the height about the apparatus 20 need not necessarily be uniform depending on the context. It will also be appreciated that the side wall top edge 28 is free and effectively forms the upper lip of the apparatus 20 and thus the part of the apparatus 20 most exposed to an animal's teeth or claws in terms of potentially causing damage to the apparatus 20 as an animal is housed in an enclosure E such as the cage C pictured in FIG. 1 with the apparatus 20 inserted therein as shown in FIG. 2. Accordingly, in embodiments of the apparatus 20 according to aspects of the present invention, the materials and dimensions of construction may be varied to suit a particular context, such as dictated by the type of enclosure and type of animal to be housed. For example, relatively thinner-walled and/or shorter skins 20 may be employed in connection with housing animals such as lizards, snakes, spiders, etc. that are not known to chew and relatively thicker-walled and/or taller skins 20, including extending the full height of the enclosure E, may be employed in connection with housing animals such as rats, hamsters, mice, rabbits, etc. that are more known for chewing or gnawing. Such approaches along with material selection for the skin apparatus 20 may be employed in any appropriate combinations to effectively line or surround an enclosure, in whole or in part, and house the intended animal therein. In terms of the material of construction for the skin 20, specifically, it may be substantially clear/transparent, translucent, or colored or tinted semi-rigid plastic such as polyethylene, polyurethane, or any other such plastic, foam of varying porosity, cardboard of varying thickness and color, or any other suitable material now known or later developed, any such material being “semi-rigid” in the sense of it being somewhat flexible or pliable but having sufficient stiffness, for example, to stand vertically and maintain a substantially planar form, such as the side wall 24 of the apparatus 20, particularly in those embodiments such as are shown in FIGS. 1-8, 10 and 11 wherein the skin
is positioned within the enclosure E. But in other alternative embodiments such as shown in FIGS. 12-15, the skin 20 may be configured for being positioned about the outside of an enclosure E as well, in which case any such skin 20 may again be somewhat semi-rigid as depicted in FIGS. 12 and 13 or somewhat more flexible as depicted in FIGS. 14 and 15, more about which is said below in connection with those respective alternative embodiments. Again, any such skin can be formed employing any suitable process based on the material of construction and other factors. Moreover, though not shown, the upper lip or edge 28 of the side wall 24 may be formed thicker than the rest of the wall or be reinforced in some manner such as an over-molded or adhered bead or lip structure along the top edge to again attempt to prevent damage as by chewing in this most susceptible portion of the skin apparatus 20. Those skilled in the art will appreciate that all such variations are possible in the present invention without departing from its spirit and scope such that the illustrated embodiment is to be expressly understood as being non-limiting, as are all others.

As also shown in FIG. 1, the skin apparatus 20 may be formed, for example, on its bottom wall 22 with an upwardly opening receptacle 50. In the exemplary embodiment, the receptacle 50 is formed by a lip 52 extending upwardly from the bottom wall 22 that thereby defines one or more troughs 54 thus built right into the floor of the skin apparatus 20—here two such troughs 54 so as to contain, for example, food and water. Those skilled in the art will appreciate that a variety of such features may thus be incorporated within the apparatus 20, whether formed integrally therewith as through a molding or other such fabrication process or as later installed thereon, which variations will be further appreciated with reference to the additional embodiments of the present invention shown and described herein below. It will be further appreciated that some such features and variations are, practically speaking, best employed in connection with skins configured for removable installation within an enclosure E, such as the receptacle 50, while other features and variations may be employed even in skins configured for being positioned about or receiving therein the enclosure E.

Turing now to FIG. 2, there is shown an enlarged perspective view of the skin apparatus 20 of FIG. 1 now inserted within the cage C. Preferably, the apparatus 20 is configured to have a substantially close or net fit within the enclosure E so as to maintain the same general inside space or volume and minimize the ability or temptation of the animal to try to gnaw on or get behind the side walls 24 (FIG. 1) while still being sufficiently loose to be slidably received in and removed from the enclosure E. As can be seen, in the illustrated embodiment, the height 30 (FIG. 1) of the apparatus 20 locates its top edge 28 (FIG. 1) at or more than halfway up the height of the cage C itself. Once more, those skilled in the art will appreciate that other heights of the apparatus 20, or configurations of its side wall 24 (FIG. 1), are possible depending on various factors, including the kind of enclosure and the kind of animal to be housed therein, without departing from the spirit and scope of the invention. Here, there is further shown shavings S placed in the bottom of the skin apparatus 20 and, within the receptacle 50, food F in one of the two troughs 54 (FIG. 1) and water W in the other. Accordingly, the animal housed within the cage C, here a rodent R pictured substantially as a Guinea Pig, is comfortably and safely accommodated, including having built-in areas in the bottom wall 22 (FIG. 1) of the apparatus 20 for holding food F and water W, conveniently in a single or unitary skin so as to thereby retain the shavings S therein as by providing a side wall 24 (FIG. 1) of sufficient height 30 (FIG. 1). It will be appreciated that by forming the apparatus 20 integrally, the receptacle 50 is thus also prevented from being disturbed or tipped so as to inadvertently spill the food F or water W stored therein, which is a common issue with free or separate bowls and the like leading to premature spoliation of the shavings S or other bedding or material placed within the enclosure E, particularly around the feeding area, as well as of course waste of the food and water themselves. It will be further appreciated once more that regardless of the height of the apparatus 20, by forming it from a substantially clear plastic or other such material, viewing in and out of the enclosure E is readily achieved, or not compromised, whilst employing the apparatus 20. And further regardless of the height of the apparatus 20, though even further enabled by making the side walls 24 (FIG. 1) effectively half height, there is sufficient airflow to the interior space of the cage C and to the animal R based on at least the unblocked top door D that is also of wire construction or is otherwise perforated or vented for airflow.

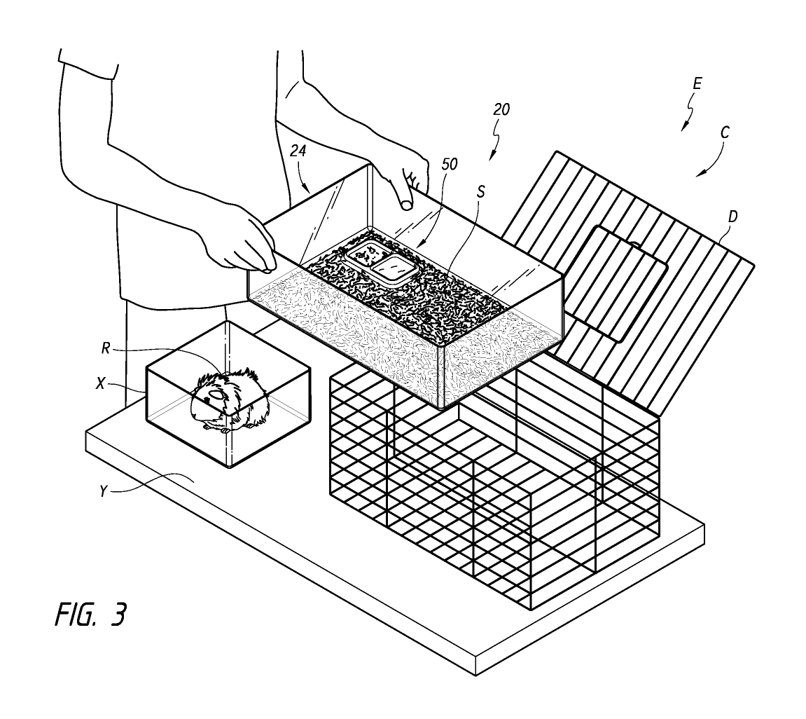

Referring next to FIG. 3, there is shown a reduced-in-scale perspective view depicting the changing out of the skin apparatus 20, as when the shavings S have become soiled. Though the apparatus 20 could be cleaned out just as can be the cage C itself and reused, in the preferred embodiment it is constructed in such a manner as shown and described herein as to be disposable, apparatus, soiled shavings, and all. As such and as shown, the housed animal such as rodent R may be removed from the cage C and placed in a temporary enclosure X positioned on the same surface Y on which the cage C sits or any other nearby surface while the used apparatus 20 is removed from the cage C as through the now open top door D as by grasping the side walls 24 and, in the exemplary embodiment, discarded. Not shown, a clean apparatus 20 is then simply inserted within the cage 20 in like manner, fresh shavings, food and water inserted therein, and the animal R returned to the main cage C as before as shown in FIG. 2.

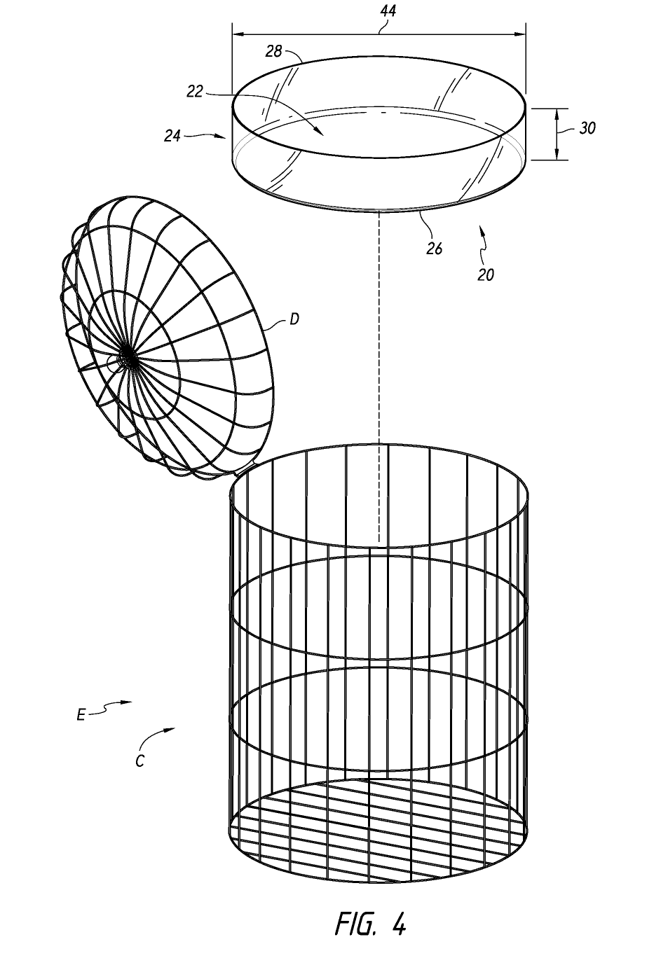

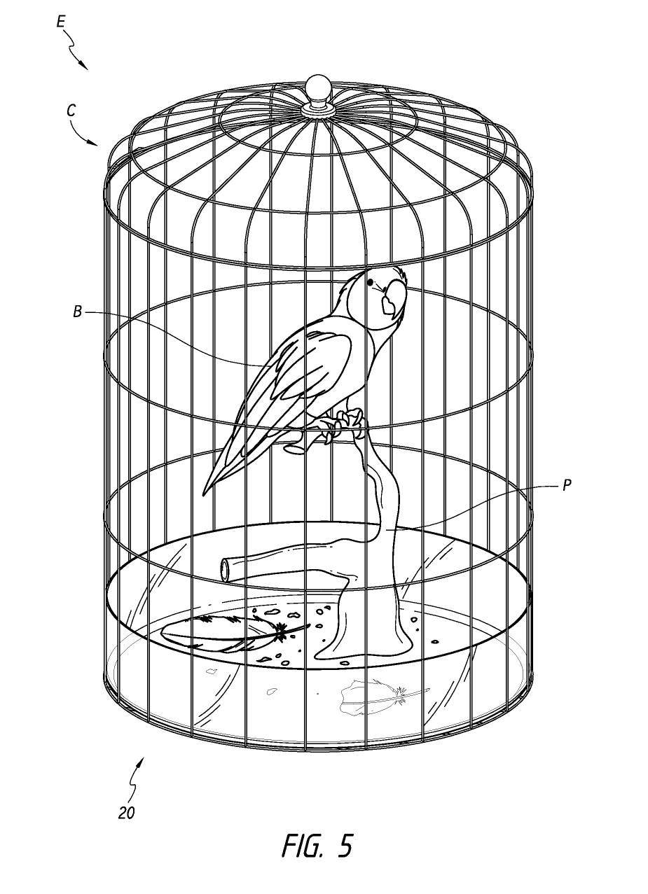

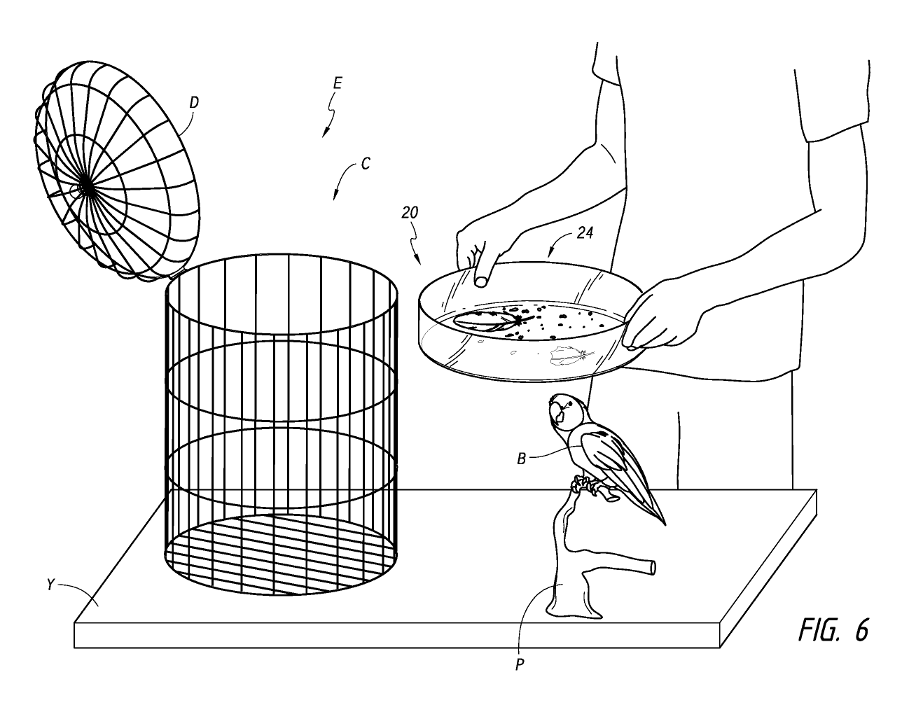

Turning now to FIG. 4, there is shown an alternative skin apparatus 20 that is substantially round or dish-shaped and thus configured for being removably placed within a substantially round and relatively taller bird cage C. As in the exemplary embodiment of FIGS. 1-3, the enclosure E is thus configured as a wire cage with a substantially top-opening door D. And as in the first exemplary embodiment, the skin apparatus 20 is again configured as generally having a bottom wall 22 and an upwardly-extending side wall 24 joined to the bottom wall 22 along a side wall bottom edge 26, the side wall then extending to an opposite side wall top edge 28. Once more, the distance between the side wall bottom and top edges 26, 28, defines the height 30 of the apparatus 20. As shown in FIG. 5, such an alternative round skin apparatus 20 is then placed within the corresponding round cage C so as to substantially cover the bottom thereof, with the side wall 24 extending upwardly sufficiently to catch and retain most bird droppings, feathers and the like that it is desirable be contained and disposed of. A perch P may also be placed on the bottom wall 22 (FIG. 4) of the apparatus 20 as desired for housing the bird B. It will be appreciated that such a perch P may be separate from or integral with the apparatus 20, as can again be feeding devices and the like. Next, as shown in FIG. 6, when the bird cage C is to be cleaned out, the bird B and perch P, if any and if separate, may simply be removed from the cage C through any door D configured therein and placed on an adjoining or nearby surface Y while the apparatus 20 is then lifted out of the cage C, as again by grasping the side wall 24. A clean skin apparatus 20 may then be inserted in the cage C through the open door D and the bird B and any other accessories replaced therein as depicted in FIG. 5.

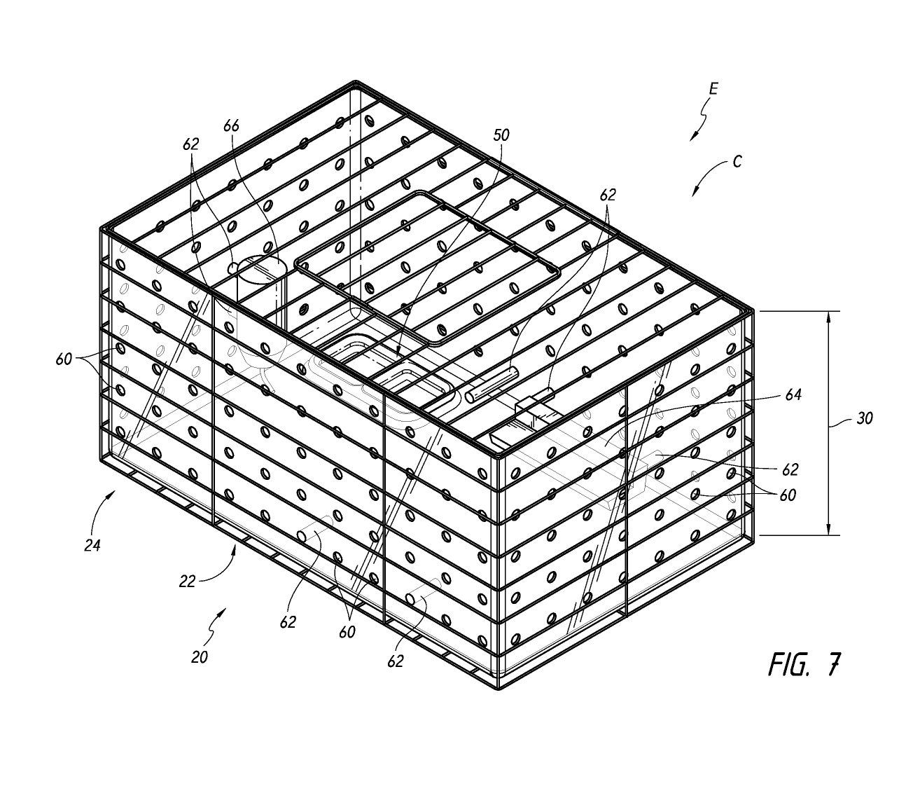

Referring now to FIG. 7, there is shown still another exemplary embodiment skin apparatus 20, here already installed within a substantially rectangular cage C much like that of FIGS. 1-3. However, the apparatus 20 shown here differs from that of FIGS. 1-3 in a number of respects. First, the side walls 24 define a height 30 that approximates the full height of the cage C. Relatedly, for at least airflow and weight/material reduction the four side walls 24 are perforated, or formed with numerous spaced-apart holes 60 therethrough. In addition, such holes 60 also allow for installation, whether permanent or integral or temporary, of various accessories. As shown, pegs 62 of varying lengths may be positioned in select ones of the holes 60, which pegs 62 provide objects for an animal housed therein to climb or perch on. Moreover, such pegs 62 may also serve effectively as mounting hardware for other accessories. For example, two pegs 62 in horizontally-aligned holes 60 may support a relatively larger perch 64 for one or more animals to climb, play, stand, sit, or lay on, and two pegs 62 in vertically-aligned holes 60 may serve as mounts for a feeder 66 as may dispense water or other food or nutrients. Such an apparatus 20 may of course include additional or different accessories, such that those shown and described are to be understood as merely illustrative of features and aspects of the invention and non-limiting. Further, as shown, the bottom wall 22 of the skin apparatus 20 may again be formed with an upwardly opening receptacle 50 as well. It will be appreciated that such an alternative apparatus 20 in various related forms may be ideal for housing animals known to chew, such as mice and rats, rabbits, and the like, since the side walls 24 extend basically to the top of the cage C and thus render the top edges of the side walls 24 generally unexposed or not readily accessible.

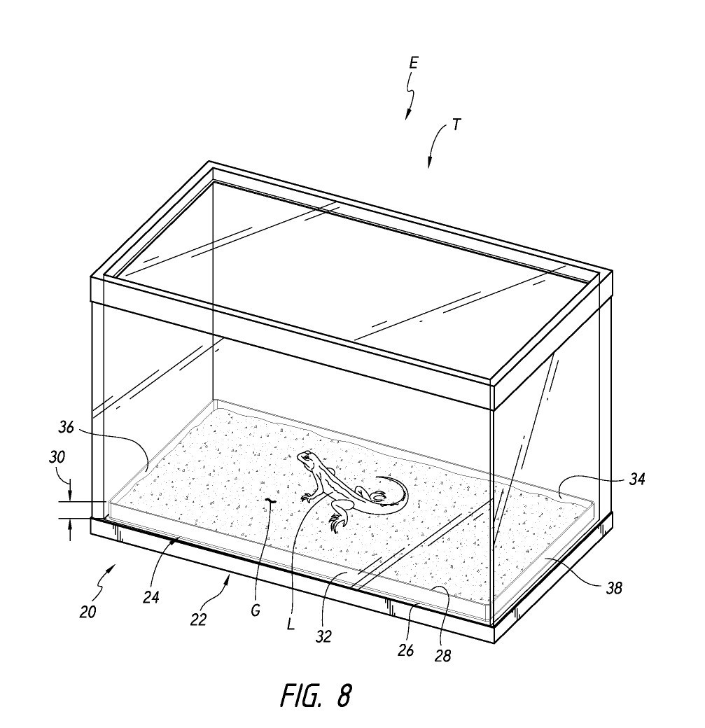

Turning next to FIG. 8, there is shown a still further exemplary embodiment skin apparatus 20 installed here in an enclosure E configured as a conventional glass tank T. As shown, such an enclosure E might house a lizard L or the like (e.g., snake, frog, or other reptile as well as small mammals, etc.). Here, the apparatus 20 is thus configured with a bottom wall 22 and side walls 24 again forming an overall rectangular shape. Specifically, there are once more opposite front and rear walls 32, 34 and opposite left and right walls 36, 38, each such side wall again connected to the bottom wall 22 along a side wall bottom edge 26 and having an opposite side wall top edge 28 defining a height 30. In the alternative exemplary embodiment shown, the height 30 of the side walls 24 is relatively short, effectively just enough to contain gravel G or other such material to be used in the bottom of the enclosure E. In a context wherein small reptiles or perhaps mammals not known particularly for chewing and gnawing are to be housed in the tank T, such a relatively short skin 20 would be effective while minimizing any unwanted visual effects as well as the overall amount of material and thus the cost of the apparatus 20. Once again, other variations in the skin apparatus 20 as might be dictated, at least in part, by the type of animal and enclosure, are possible without departing from the spirit and scope of the present invention.

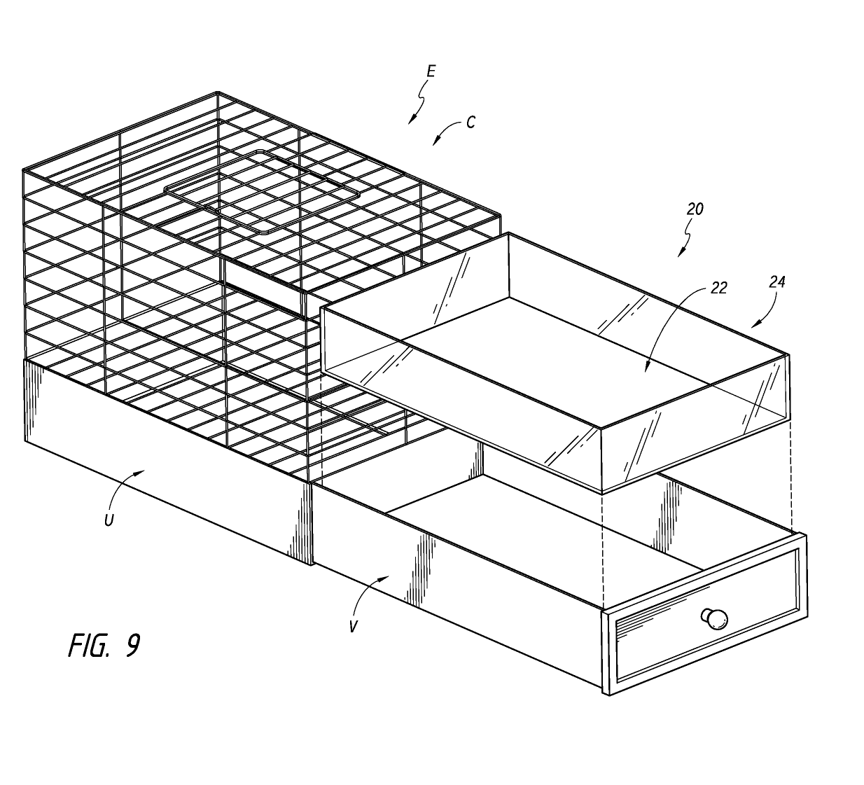

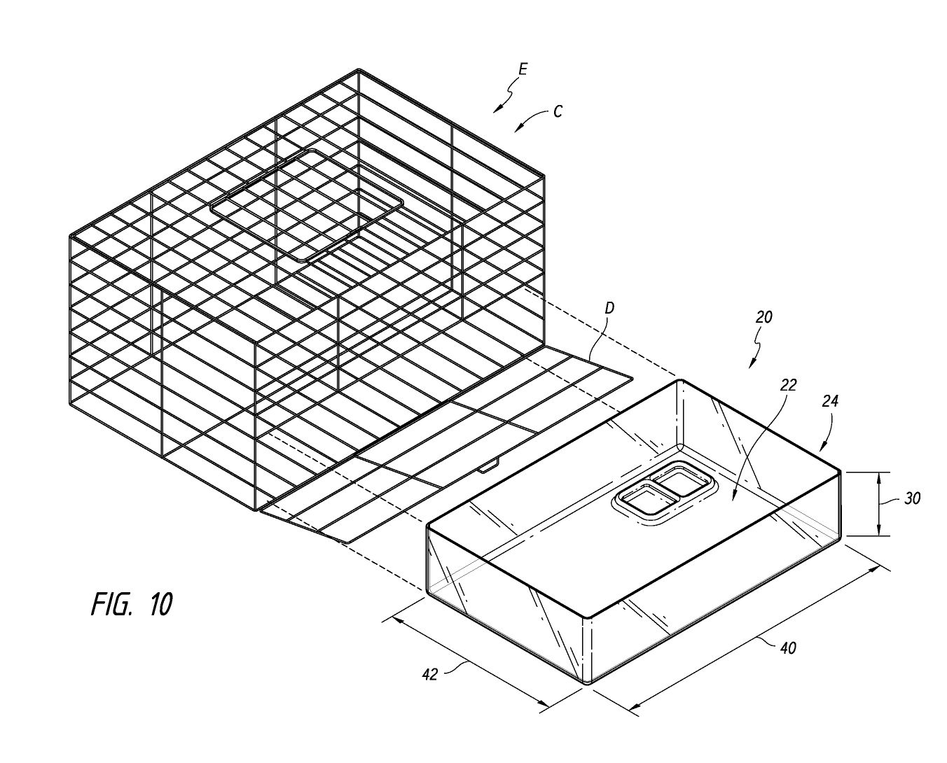

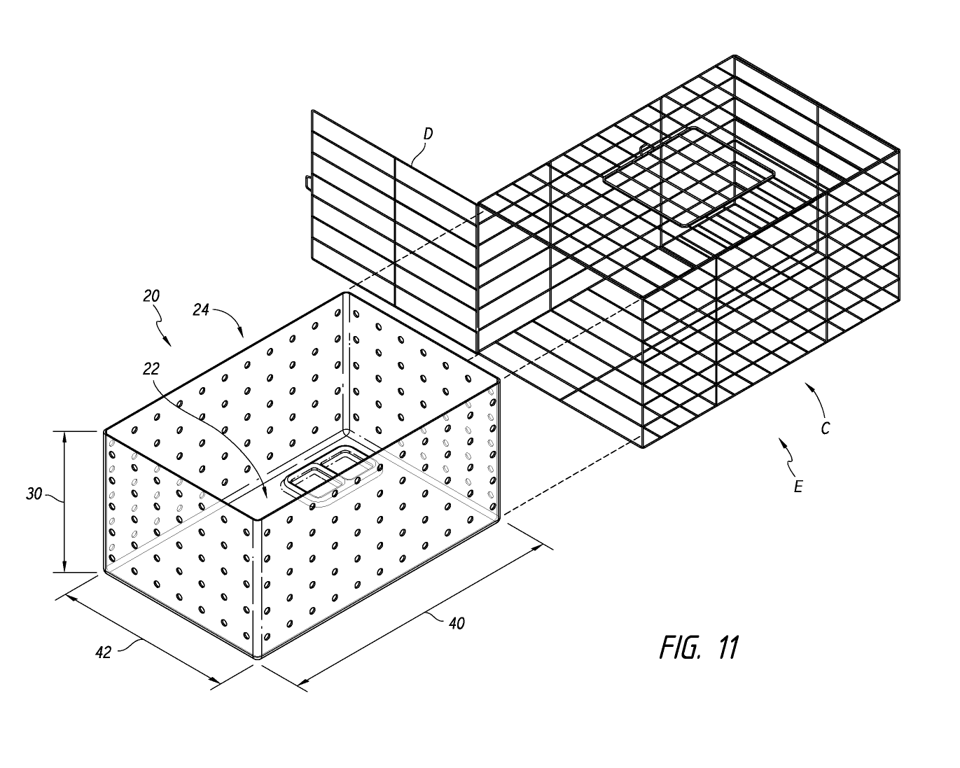

In FIGS. 9-11 there are shown exploded perspective views of various alternative wire cage configurations and exemplary skin apparatuses being employed therewith. First, in FIG. 9, there is depicted a cage C positioned on or over a support base U configured on one end with a drawer V slidably engaged or engageable therein. In the art, such drawer V might catch animal droppings directly and thus be cleaned out regularly, or might contain a paper or plastic lining or the like designed to catch the droppings and be disposed of with them. However, such paper or plastic linings may tear or leak through or, not having sides, may otherwise simply not contain all droppings and other spoilage, whereby the drawer V must still be periodically cleaned out. By comparison, by placing a skin apparatus 20 within the drawer V as shown, such apparatus 20 again being configured with a bottom wall 22 and integral side walls 24, it is thus more likely that all such animal droppings are contained therein and in no way contaminate or soil the drawer V itself, whereby the cages C are effectively cleaned and maintained simply by removing from and replacing in the drawer V a skin apparatus 20 according to aspects of the present invention. In FIG. 10, there is shown an alternative arrangement wherein a cage C is configured to open along a front side, and there only via effectively a half door D, such that a substantially half-height skin apparatus 20 as also shown in FIGS. 1-3 may be selectively employed, the apparatus 20 having height 30, length 40 and width 42 substantially conforming to the door D and related door opening and the overall footprint of the cage C. And in FIG. 11, there is shown a cage C that opens fully via a door D on an end so as to accommodate even a full-height skin apparatus 20 as shown, analogous to that in FIG. 7 except not showing the various accessories for simplicity and clarity. Here, the height 30, length 40 and width 42 of the apparatus 20 is again so as to conform to the door D and related door opening and the overall footprint of the cage C. It will be appreciated that particularly in such a case as in FIG. 11 or in the embodiment of FIGS. 1-3 wherein the cage C opens effectively on an entire side that the apparatus 20 may thus be substantially the same as or smaller than the door D and related opening. In other words, while a full-height apparatus 20 is shown in FIG. 11 in connection with a door D that is effectively the entire side of the cage C, a smaller or shorter apparatus 20 such as shown in FIGS. 1-3 and 8-10 may be employed in connection with a cage C as shown in FIG. 11 just as easily. Again, those skilled in the art will appreciate that other considerations such as the type of animal to be housed in the enclosure E would be taken into account in selecting a particular skin apparatus 20. It will thus be appreciated more generally that the apparatus 20 may be virtually any size and height to accommodate any size cage or tank, now known or later developed. Such apparatuses 20 may further be formed having any angles or rounded or contoured edges beyond those shown and described and may even have on its walls, particularly where translucent or even tinted or colored plastic or cardboard is employed patterns, designs, characters, etc. for further visual or aesthetic effects. While the various apparatuses 20 are shown as being handled generally by grasping the side walls 24 (see FIGS. 3 and 6), it will be appreciated that handles of any form now known or later developed may also be incorporated into the side walls 24 or other part of the skins 20.

Referring next to FIGS. 12 and 13, there are shown perspective views of still another alternative skin apparatus 20 here configured to receive an enclosure E rather than being received within such an enclosure E, again configured for purposes of illustration as a conventional substantially rectangular wire cage C. First, in FIG. 12, there is shown an exploded perspective view of the cage C positioned above the apparatus 20. The skin apparatus 20 is again configured having a substantially rectangular shape as well defined by a bottom wall 22 and four integral side walls 24, including relatively longer and of substantially the same length and height opposite front and rear walls 32, 34 and relatively shorter and of substantially the same length and height opposite left and right walls 36, 38, all such walls being interconnected so as to form a substantially unitary apparatus 20. The interior space of the skin apparatus 20 thus is configured—sized and shaped—to accommodate the cage C or other intended enclosure E as best shown in FIG. 13. As also shown, the top edge 28 of the two long sides 32, 34 is formed having a handle 80, here configured as a lengthwise and substantially outwardly-turned flange 82. Thus, as shown in FIG. 13, the cage C may be inserted within the skin apparatus 20 without any interference by the flanges 82, and when so installed, the flanges 82 serves as handles for carrying the cage C. It will be appreciated by those skilled in the art that such handles 80 or particular flanges 82 may take a number of forms and be positioned in a variety of locations on or about the apparatus 20, such that the particular location, configuration, and orientation of the flanges 82 shown in FIGS. 12 and 13 are to be understood as merely illustrative of features and aspects of the present invention and non-limiting. For example, the handles 80 configured as flanges 82 could have instead been configured on the shorter sides 36, 38 or both the long and short sides and/or could extend along only a portion of the top edge 28 rather than entirety of such edge along the respective sides on which the handles 80 are positioned. It will be appreciated that so long as the cage C is housed within the skin apparatus 20, any droppings or other material within the cage effectively cannot escape the apparatus 20 bounding the bottom and at least a portion of the sides of the cage C, such that once more, when it comes time to freshen up the cage C, that may be as simple as removing the cage C from the skin apparatus 20, preferably discarding and replacing or cleaning out the apparatus 20, and returning the cage C to the new or cleaned apparatus 20 as shown in FIG. 13.

Finally, turning to FIGS. 14 and 15, there is shown yet another exemplary embodiment skin apparatus 20, here also as one that is configured to go about the outside of the cage C or other enclosure E but employing a more flexible material capable of folding, bunching or the like. As shown first in FIG. 14, a conventional substantially rectangular wire cage C is placed within the apparatus 20. In the first operational mode illustrated, the side walls 24 of the apparatus 20 are folded or bunched down substantially around the base of the cage C. It will be appreciated that by employing a sufficient amount and/or thickness of material, the bunched side wall 24 of the apparatus 20 still effectively retains any droppings or other material that might tend to otherwise leave the cage C. Then, when the cage is to be “cleaned,” once more, the apparatus 20 may simply be discarded and the cage C placed within a new skin 20 as shown in FIG. 14. Furthermore, as shown, the top edge 28 of the side wall 24 may be configured with one or more handle 80, here shown as a loop 84 affixed to the long sides 32, 34 of the apparatus 20. Then, when the cage C is to be transported, as shown in FIG. 15, the loop handles 80 may be grasped and the side wall 24 of the apparatus 20 raised until substantially taught. In the exemplary embodiment shown, the total height of the side wall 24 approximates that of the cage C, which has the advantage in transport of not only more completely housing or containing all droppings and materials within the cage C even as it is potentially jostled or disoriented a bit but also providing a calming effect for any animal still in the cage C by cutting down on the visual stimulation during movement, which may already be unsettling for the creature. As further shown in FIG. 15, the loops 84 may be of sufficient length such that when the side walls 24 are extended both loops 84 may be grasped in one hand simultaneously. Once again, those skilled in the art will appreciate that a variety of other such embodiments are possible in the present invention without departing from its spirit and scope, such as changing the configuration or locations of the loop handles 80. Such a relatively flexible skin apparatus 20 may be formed of any suitable material now known or later developed, and may particularly have varying qualities related to thickness, opaqueness, porosity or breathability, stiffness, and the like in order to suit a particular application, including but not limited to plastic or fabric.

To summarize, regarding the exemplary embodiments of the present invention as shown and described herein, it will be appreciated that a removable skin apparatus is disclosed and configured for being effectively and conveniently placed and utilized within an animal enclosure. Because the principles of the invention may be practiced in a number of configurations beyond those shown and described, it is to be understood that the invention is not in any way limited by the exemplary embodiments, but is generally able to take numerous forms without departing from the spirit and scope of the invention. It will also be appreciated by those skilled in the art that the present invention is not limited to the particular geometries and materials of construction disclosed, but may instead entail other functionally comparable structures or materials, now known or later developed, without departing from the spirit and scope of the invention. Furthermore, the various features of each of the above-described embodiments may be combined in any logical manner and are intended to be included within the scope of the present invention.

While aspects of the invention have been described with reference to at least one exemplary embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

What is claimed is:

1. A skin apparatus for removable use with an animal enclosure, the apparatus comprising:
a bottom wall; and
a side wall integral with the bottom wall substantially along a side wall bottom edge and extending therefrom so as to terminate in an opposite side wall top edge, the distance between the side wall bottom edge and the side wall top edge defining an effective height of the apparatus so as to be removably engaged with the enclosure.

2. The apparatus of claim 1 wherein the bottom wall is configured with an integral receptacle.

3. The apparatus of claim 2 wherein the receptacle is formed by a substantially upwardly extending lip bounding at least one trough.

4. The apparatus of claim 1 further comprising:
multiple holes formed in the side wall so as to communicate therethrough; and
at least one peg inserted in a hole.

5. The apparatus of claim 4 further comprising:
two pegs positioned in substantially horizontally aligned holes formed in the side wall; and
a perch installed on the two pegs.

6. The apparatus of claim 4 further comprising:
two pegs positioned in substantially vertically aligned holes formed in the side wall; and
a feeder installed on the two pegs.

7. The apparatus of claim 1 wherein the side wall comprises:
a front wall;
a rear wall substantially opposite the front wall;
a left wall between the front and rear walls; and
a right wall substantially opposite the left wall and also between the front and rear walls, the front, rear, left and right walls all being integral with the bottom wall and adjacent such side walls so as to form the apparatus, the front and rear walls together with the bottom wall defining an effective length of the apparatus and the left and right walls together with the bottom wall defining an effective width of the apparatus, the length and width of the apparatus substantially conforming to the dimensions of the enclosure.

8. The apparatus of claim 1 wherein the bottom wall and the side wall are round.

9. The apparatus of claim 1 wherein the height of the apparatus is less than that of the enclosure.

10. The apparatus of claim 1 wherein the height of the apparatus is less than half that of the enclosure.

11. The apparatus of claim 1 wherein the height of the apparatus is substantially equivalent to that of the enclosure.

12. The apparatus of claim 1 wherein the bottom and side walls are formed of a material selected from the group consisting of semi-rigid plastic and cardboard.

13. The apparatus of claim 12 wherein the plastic is substantially transparent.

14. The apparatus of claim 1 wherein the bottom and side walls are formed of a material selected from the group consisting of plastic and fabric.

15. The apparatus of claim 1 wherein a handle is formed substantially at the side wall top edge.

16. The apparatus of claim 15 wherein the handle is configured as a flange.

17. The apparatus of claim 15 wherein the handle is configured as a loop.

18. The apparatus of claim 17 wherein:
the height of the apparatus is substantially equivalent to that of the enclosure; and
two loops are formed on opposite walls of the apparatus and configured so as to substantially meet above the enclosure, whereby transport of the enclosure by one hand via the apparatus is facilitated.

19. A skin apparatus for removable use within an animal enclosure, the apparatus comprising:
a bottom wall having formed therein an integral receptacle formed by a substantially upwardly extending lip bounding at least one trough; and
a side wall integral with the bottom wall substantially along a side wall bottom edge and extending therefrom so as to terminate in an opposite side wall top edge, the distance between the side wall bottom edge and the side wall top edge defining an effective height of the apparatus so as to be removably received within the enclosure through a door thereof; wherein:
the bottom and side walls are formed of a material selected from the group consisting of semi-rigid plastic and cardboard.

20. A skin apparatus for removable use within an animal enclosure, the apparatus comprising:
a bottom wall having formed therein an integral receptacle formed by a substantially upwardly extending lip bounding at least one trough; and
a side wall integral with the bottom wall substantially along a side wall bottom edge and extending therefrom so as to terminate in an opposite side wall top edge, the distance between the side wall bottom edge and the side wall top edge defining an effective height of the apparatus so as to be removably received within the enclosure through a door thereof, the side wall having multiple holes formed therein for communication therethrough; wherein:
the bottom and side walls are formed of a substantially transparent, semi-rigid plastic; and
the height of the apparatus is at least half that of the enclosure.
